(19) United States
(12) Patent Application Publication
(10) Pub. No.: US 2025/0217719 A1
(43) Pub. Date: Jul. 3, 2025

(54) Method and Device for Model Aggregation in Federated Learning

(71) Applicant: Robert Bosch GmbH, Stuttgart (DE)

(72) Inventors: Yifan Du, Shanghai (CN); Li Wu, Shanghai (CN)

(21) Appl. No.: 19/002,195

(22) Filed: Dec. 26, 2024

(30) Foreign Application Priority Data
Dec. 27, 2023 (CN) 2023 1182 6669.1

(51) Int. Cl. G06N 20/20

(52) U.S. Cl. CPC G06N 20/20

(57) ABSTRACT

A method is for model aggregation in federated learning. The method is performed by a source computing node, and the source computing node is communicatively coupled with a target computing node. The method includes receiving metadata of the target computing node, and generating a model aggregation decision based on the metadata and an aggregation history of the source computing node. In response to generating a decision indicative of performing the model aggregation, the method includes performing model aggregation on a local model of the source computing node and a local model of the target computing node, and updating the local model of the source computing node to an aggregated model.

This application claims priority under 35 U.S.C. § 119 to patent application no. CN 2023 1182 6669.1, filed on Dec. 27, 2023 in China, the disclosure of which is incorporated herein by reference in its entirety.

The present disclosure relates generally to the field of artificial intelligence, and more particularly relates to a method and a device for model aggregation in federated learning.

### BACKGROUND

In the field of artificial intelligence, a machine learning framework called federated learning is provided. Federated learning can also be referred to as federated machine learning, alliance learning, joint learning, and the like; as a distributed machine learning technique, it can collectively train a global model utilizing multiple terminal devices and a central server in the cloud without the need for centralized management of training data. Unlike traditional machine learning techniques, in federated learning, training data is not centrally managed, but is retained at various terminal devices in a distributed manner. In this way, various terminal devices may train local models, respectively, based on their local data, these trained local models may then be aggregated at the central server into a global model suitable for various terminal devices. As a result, federated learning collaboratively establishes the global model in case of fusing data from multiple parties, and meanwhile, data from various parties is retained locally on the device, thereby providing data privacy protection.

### SUMMARY

The present disclosure provides an improved mechanism to perform model aggregation in federated learning. Rather than relying on a central server to complete the model aggregation, each computing node may encounter another computing node, and a model aggregation operation is performed locally by the computing node. Such improved mechanism does not require the central server to perform the model aggregation, thereby having significant benefits in terms of flexibility, scalability, security, and costs, etc.

According to one aspect of the present disclosure, there is provided a method for model aggregation in federated learning, wherein the method is performed by a source computing node, and the source computing node is communicatively coupled with a target computing node, the method comprising: receiving metadata of the target computing node; generating a model aggregation decision based on the metadata and an aggregation history of the source computing node; in response to generating a decision indicative of performing the model aggregation, performing model aggregation on a local model of the source computing node and a local model of the target computing node; and updating the local model of the source computing node to an aggregated model.

According to yet another aspect of the present disclosure, there is provided with a device for model aggregation in federated learning, comprising: a memory; and a processor. The processor is coupled with the memory and is configured to perform the method according to any one of various examples of the present disclosure.

According to still another aspect of the present disclosure, there is provided with a computer-readable medium storing a computer program comprising instructions, the instructions, when executed by a processor, causing the processor to be configured to perform the method according to any one of various examples of the present disclosure.

According to another aspect of the present disclosure, there is provided with a computer program product comprising instructions, the instructions, when executed by a processor of the computing device, causing the processor to be configured to perform the method according to any one of various examples of the present disclosure.

### BRIEF DESCRIPTION OF THE DRAWINGS

The various examples of the subject matter to be protected are described by way of typical examples with reference to the accompanying drawings. The same reference numbers are used in different accompanying drawings to denote the same or similar components.

FIG. 1 shows a schematic diagram of a centralized federated learning system according to one example of the present disclosure.

FIG. 2 shows a schematic diagram of a decentralized federated learning system according to one example of the present disclosure.

FIG. 3 shows a timing diagram of a model aggregation operation according to one example of the present disclosure.

FIG. 4 shows a flow chart of a method for performing a model aggregation decision, consistent with according to one example of the present disclosure.

FIG. 5 shows a flow chart of a method for model aggregation in federated learning according to one example of the present disclosure.

FIG. 6 shows a block graph of a computing device according to one example of the present disclosure, wherein the computing device may implement the above-described method for model aggregation in federated learning.

### DETAILED DESCRIPTION

In the following description, numerous specific details are set forth to provide a thorough understanding of the examples of the present disclosure. However, those skilled in the relevant art will recognize that the present disclosure can be practiced without one or more of the specific details, or by using alternative methods, components, etc., to practice the present disclosure. In some instances, well-known structures and operations are not shown or described in detail to avoid unnecessarily obscuring the present disclosure.

In the field of artificial intelligence, the learning process (or also referred to as a “model training process”) is typically implemented in the cloud, which is often due to the learning process requiring to process a large amount of data and thus requiring higher computing power. In recent years, as the increase of the computing power of terminal devices, it has been proposed that the learning process can be transferred from the cloud to the terminal devices. Transferring the learning process to the terminal device is beneficial for the personalization of models. Training personalized models often requires substantial manual intervention or feedback such that the trained models meet personalized needs. The models referred to in the present disclosure may refer to artificial intelligence (AI) models, which may have specific model architectures and are used for performing specific tasks. Since the terminal devices train the models locally at the devices based on the local data, the models trained at the terminal devices may be referred to as local models.

Local models trained respectively at multiple terminal devices may be aggregated to obtain an aggregated model. For fusing the local models of multiple terminal devices, a large number of different data samples from same data feature space may be introduced during learning, thereby helping improve the performance of an ultimately trained global model. Such process may be implemented by utilizing a machine learning framework called federated learning. In federated learning, the local models may be trained respectively at each terminal device based on local training data. The central server in the cloud may be utilized to aggregate all the trained local models into a global model that fuses the local models from various terminal devices. The local model of each terminal device can then be updated to an aggregated global model. Federated learning is particularly suitable for collaborative learning use cases that require data privacy. This is due to the fact that in federated learning, there is no need to upload privacy data to the cloud to complete the training process. Instead, the training process is performed respectively at various terminal devices.

This learning mode can be referred to as centralized federated learning due to the process described above requiring the central server in the cloud to aggregate the local models trained by various terminal devices respectively into the global model.

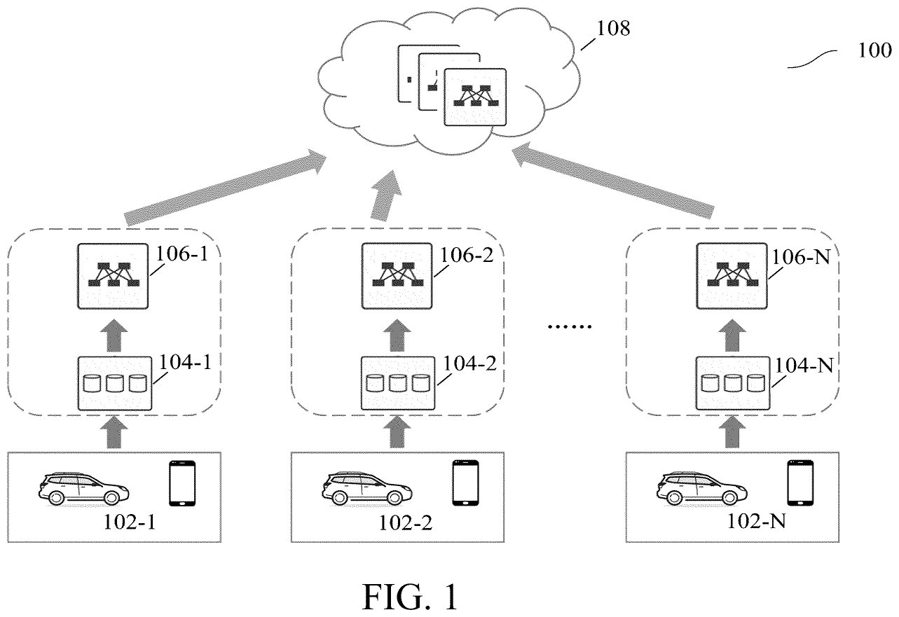

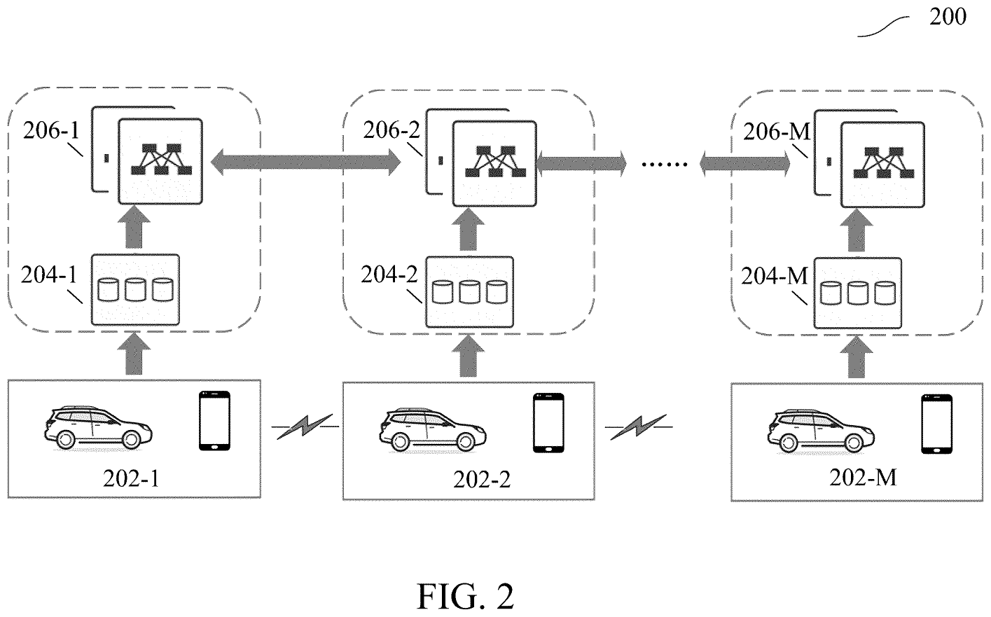

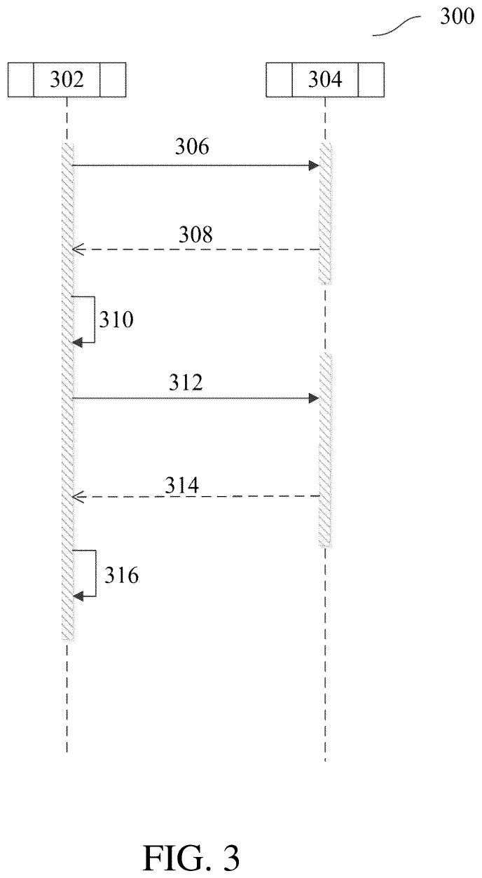

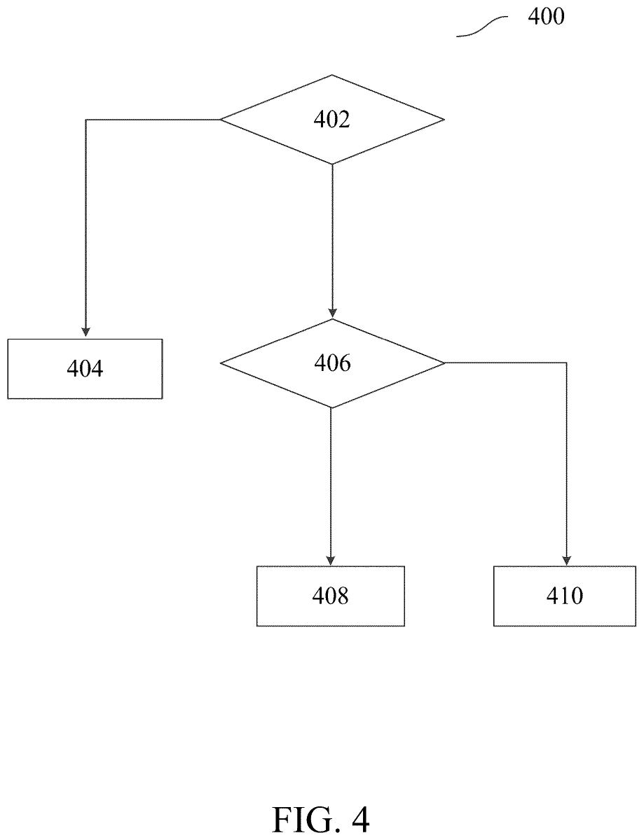

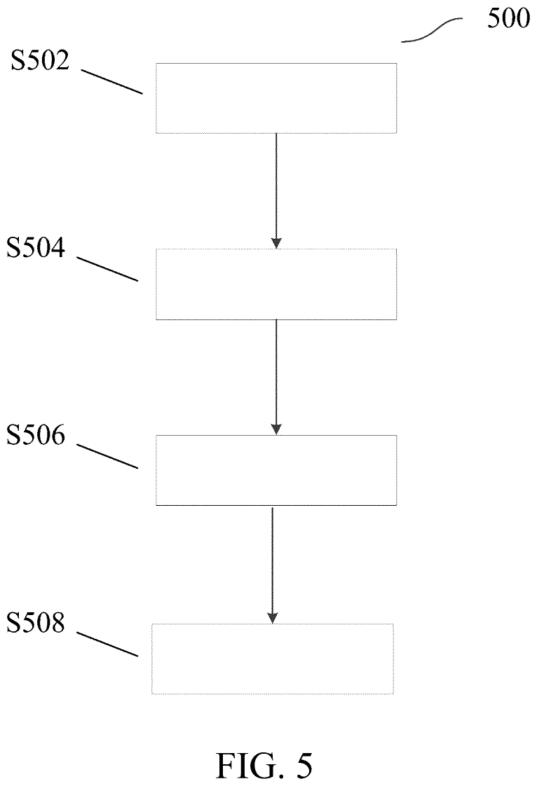

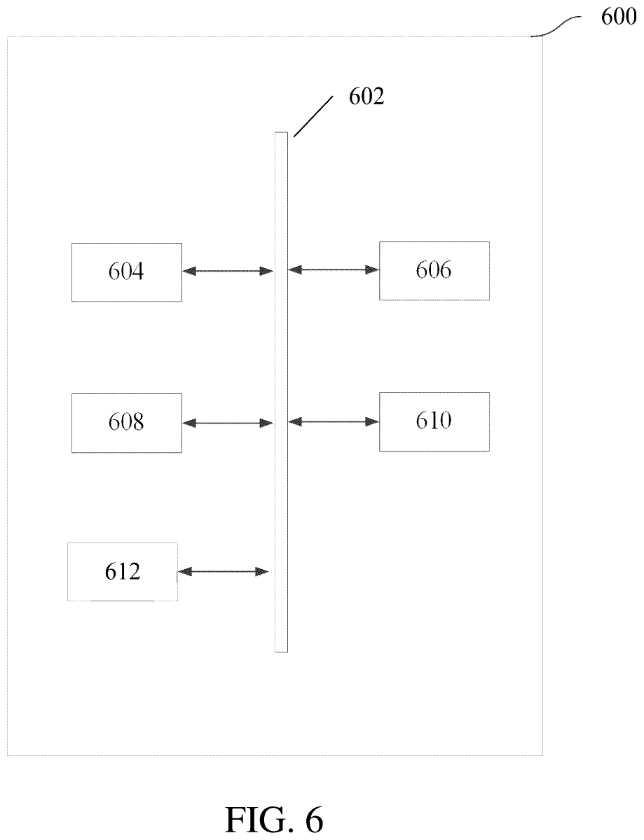

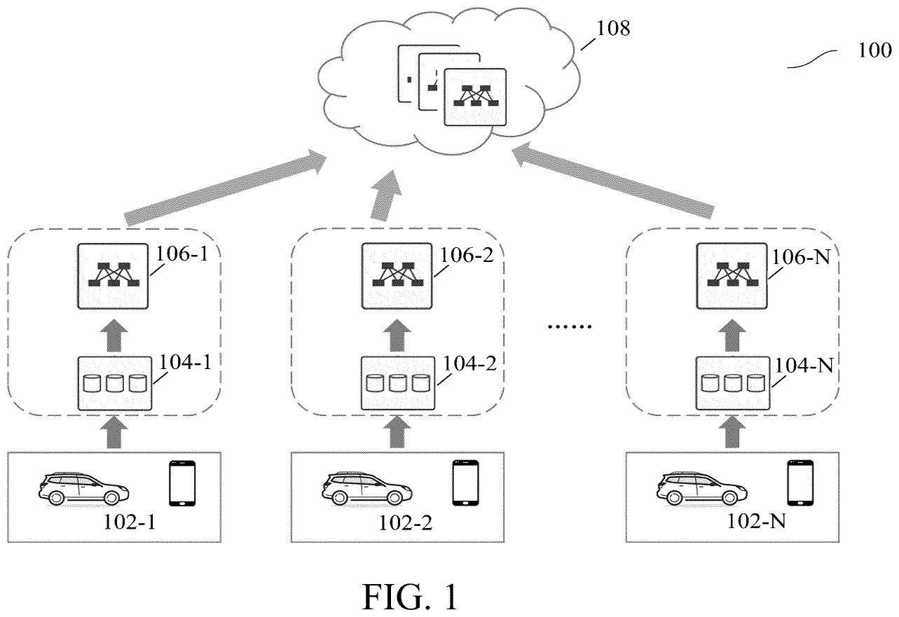

FIG. 1 shows a schematic diagram of a centralized federated learning system 100 according to one example of the present disclosure.

As shown in FIG. 1, the centralized federated learning system 100 may include a plurality of computing nodes 102, for example, computing nodes 102-1, 102-2 . . . 102-N shown in FIG. 1. The computing nodes 102 may be devices having computing power to complete a model training process in federated learning. The computing nodes may also be referred to as computing devices, terminal devices, mobile devices, and the like, and may be any type of devices such as computing devices for autonomous vehicles (e.g., vehicle control units (VCUs), electronic control units (ECUs), etc.), control units for autonomous robots, terminal devices in an IoT architecture, cell phones, a smartphones, portable computers and tablets. The model training process may be performed based on the training data 104 on the computing nodes 102 to obtain trained models 106. The training data 104 may be data local to the computing nodes 102. The local data may refer to data with at least one of the processes of generation, collection, processing, etc. of the data completed locally at the computing nodes. The models 106 that utilize the local training data 104 to train through a training process performed locally on the computing devices 102 may be referred to as local models. For example, as shown in FIG. 1, the local model 106-1 may be trained based on the local training data 104-1 on the computing node 102-1, the local model 106-2 may be trained based on the local training data 104-2 on the computing node 102-2, and the like.

The centralized federated learning system 100 may also include a central server 108 located in the cloud. The central server 108 may have a network connection with various computing nodes 102 such that the computing nodes 102 may transmit data to the central server 108 and receive data from the central server 108 via the network connection. The central server 108 may comprise one server or multiple collaborative servers and may perform a model aggregation operation. The computing nodes 102 may upload the local models 106 (e.g., model parameters of the local models 106) to the central server 108, respectively. The central server 108 may perform a model aggregation algorithm to aggregate the global model based on local models from the plurality of computing nodes 102. In one example, the model aggregation algorithm may include obtaining an algebraic average of the local model parameters to compute global model parameters. The global model may further be issued to various computing nodes 102 via the network connection by the central server 108. At each computing node 102, the local models 106 may be replaced using the global model obtained from the central server 108.

A mechanism for performing the model aggregation operation using the central server is described above in connection with FIG. 1. Such mechanism may present potential problems in terms of flexibility, scalability, security and costs, etc. due to the strong dependence on the central server.

The present disclosure provides an improved mechanism for performing model aggregation in federated learning, wherein the model aggregation is not completed dependent on the central server. Instead, model aggregation can be performed locally at the computing node when each computing node encounters another computing node. In this way, as the aggregated model is progressively propagated between various computing nodes, each computing node may ultimately have a global model that fuses local models of all the computing nodes. Since the model aggregation is performed at the computing nodes and the participation of the central server is no longer needed, this learning mode can be referred to as decentralized federated learning.

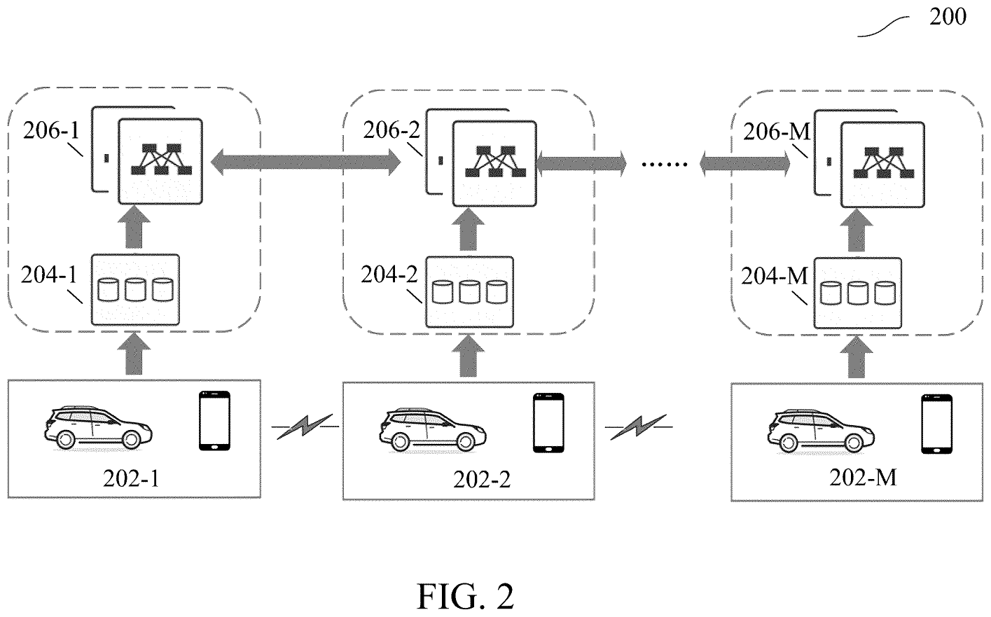

FIG. 2 shows a diagram of a decentralized federated learning system 200 according to one example of the present disclosure.

As shown in FIG. 2, the decentralized federated learning system 200 may include a plurality of computing nodes 202, for example, the computing nodes 202-1, 202-2 . . . 202-M shown in FIG. 2. The computing nodes 202 may be similar to the computing nodes 102 described above in connection with FIG. 1. The computing nodes 202 may be devices having computing power to complete a model training process in federated learning, and may be any type of devices such as computing devices for autonomous vehicles (e.g., VCUs, ECUs, etc.), control units for autonomous robots, terminal devices in an IoT architecture, cell phones, smartphones, portable computers and tablets. The model training process may be performed based on the training data 204 on the computing nodes 202 to obtain trained models 206.

The models in the present disclosure may comprise any type of AI models, e.g., conventional machine learning models (e.g., support vector machines (SVMs), Naive Bayes, decision trees, random forests, etc.), deep learning models (e.g., convolutional neural networks (CNNs), recursive neural networks (RNNs), long and short time memory networks (LSTMs), autoencoders, etc.), generating models (e.g., generative adversarial networks (GANs), linguistic models, etc.) and any other AI models that are known or will be known in the field. The models on each computing node 202 should be “same” models, in other words, the models have the same model architecture and are used for performing the same task such that they can be aggregated together. In one example application scenario where a computing node is a computing device for autonomous vehicles, the model may be used for performing a driving control decision generation task to generate a driving control decision for controlling the driving of the autonomous vehicles. In another example application scenario where the computing node is a cell phone, the model may be used for performing a content recommendation task to generate a recommended result that includes content that may be of interest to a user.

The training data 104 may be data local to the computing nodes 102. The local data may refer to data with at least one of the processes of generation, collection, processing, etc. of the data completed locally at the computing nodes. The training process specific for the model typically comprises a process of dynamically adjusting various model parameters of the models based on the training data to obtain optimized model parameters. In one example, in case that the model is a deep learning model, typical model parameters may include weights and bias. The models 206 that utilize the local training data 204 to train through a training process performed locally on the computing devices 202 may be referred to as local models. Through the training process, the local models 206 may define a set of optimized model parameters that enable the local models 206 to be capable of outputting satisfactory operational results specific for the local training data 204. For example, as shown in FIG. 2, the local model 206-1 may be trained based on the local training data 204-1 on the computing node 202-1, the local model 206-2 may be trained based on the local training data 204-2 on the computing node 202-2, and the like. In one example application scenario where the computing node discussed above is a computing device for autonomous vehicles, the training data may include data associated with driver's driving behaviors, e.g., whether a driver tends to have a smoother acceleration and deceleration, etc. Such data helps local models learn driving habits of the driver. In another example application scenario where the computing node discussed above is a cell phone, the training data may include data associated with feedback from the user on historical recommended results, for example, whether the user previously accepted particular recommended content, or the like. Such data helps local models learn user preferences.

Unlike the centralized federated learning system 100 shown in FIG. 1, the decentralized federated learning system 200 does not include a central server 108 for performing model aggregation. Instead, the model aggregation may occur when each computing node (e.g., the computing node 202-1) discovers another computing node (e.g., the computing node 202-2), and the model aggregation operation may be performed at any computing node (e.g., the computing node 202-1, or the computing node 202-2). For example, for the computing node 202-1, when encountered with the computing node 202-2, the computing node 202-1 may utilize data communication between the two to obtain model parameters of the local model 206-2 of the computing node 202-2 and perform a model aggregation operation. By way of the model aggregation operation, the model parameters of the local model 206-1 can be aggregated with model parameters of the obtained local model 206-2 at the computing node 202-1. Further, the computing node 202-1 can replace the model parameters of the local model 206-1 with aggregated model parameters such that the local model 206-1 is updated to the aggregated model.

In another aspect, the computing node 202-2 can perform the same operation to implement model aggregation. Through such process, the computing nodes 202-1 and 202-2 both have an aggregated model that fuse local models for each other. The computing nodes 202-1 and 202-2 may then utilize the aggregated model, respectively, to perform various inference tasks to obtain inference results. In one example application scenario where the computing node discussed above is a computing device for autonomous vehicles, the model may perform a driving control decision generation task to generate a driving control decision for controlling the driving of the autonomous vehicles, for example a decision associated with acceleration or deceleration of the vehicles, according to environmental perception information (e.g., the environmental perception information may be from an environmental perception sensor such as radar, Lidar and a camera). In another example application scenario where the computing node discussed above is a cell phone, the model may perform a content recommendation task to generate a recommended result that includes content that may be of interest to the user according to the user data (e.g., the user's profile, the user's geographical location, etc.).

Further, the mechanism of the present disclosure is equally applicable to any other application scenario in addition to the example application scenarios for autonomous vehicles and cell phones described above.

Although the above paragraphs only exemplify the process of performing model aggregation between the computing node 202-1 and the computing node 202-2, it is to be understood that similar processes may be performed between multiple pairs of computing nodes among the plurality of computing nodes included in the decentralized federated learning system 200, respectively. As a result, as the computing nodes continue to encounter with other computing nodes, various computing nodes can fuse more local models and can train the global model for various computing node.

There are significant benefits in canceling the setup of the central server (e.g., the central server 108 described in conjunction with FIG. 1) in the federated learning system.

In an aspect, each computing node needs to maintain a continuous and reliable network connection with the central server since the model aggregation at the central server is ongoing, e.g., the model aggregation needs to be performed every time the local model parameters are updated. In contrast, in the decentralized federated learning system 200, such network connection does not need to be maintained, thereby providing greater flexibility.

In another aspect, in case that a large number of computing nodes are in network communication with the central server, a network jam may cause delays in model aggregation. Moreover, since different cloud platforms are typically isolated due to the effects of compatibility and data protection policies, the transfer of global model parameters generated at one cloud platform to another cloud platform is often limited. In contrast, in the decentralized federated learning system 200, the issues of delays and extension limitations associated with the central server are avoided.

In another aspect, in a scenario where the model aggregation is performed using the central server, there is a need to centrally store a large amount of data (e.g., model parameters uploaded from various computing nodes) in the central server and therefore may face the issue of data security. In contrast, in the decentralized federated learning system 200, the data is stored in a decentralized manner and thus may have enhanced data security.

In another aspect, performing the model aggregation using the central server may face cost issues. For example, high data communication bandwidths and strong computing power required by the central server involve higher costs. In contrast, the above-mentioned incremental costs are not involved in the decentralized federated learning system 200.

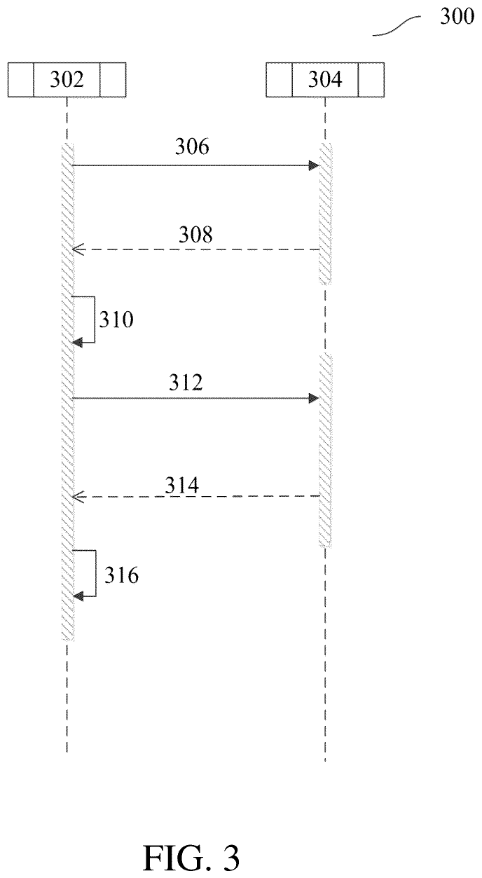

FIG. 3 shows a timing diagram of a model aggregation operation 300 according to one example of the present disclosure. It will be understood that the model aggregation operation 300 relates to model aggregation that occurs between any two computing nodes (e.g., the computing node 202-1 and the computing node 202-2 described above in connection with the FIG. 2) upon encountering. In the whole decentralized federated learning system, multiple model aggregation operations 300 can be performed as various computing nodes continue to encounter with other computing nodes. For clarity, two objects involved in the process shown in FIG. 3 are referred to as a source computing node 302 and a target computing node 304, respectively.

The source computing node 302 may discover the target computing node 304 and establish data communication with the target computing node 304 in the decentralized federated learning system before the process shown in FIG. 3 starts to be performed for facilitating the performing subsequent model aggregation operations. In one example, the discovery of the source computing node 302 to the target computing node 304 may be implemented by utilizing a service discovery technique known in the prior art. The service discovery technique is the technique in which a computing device running a particular service is capable of discovering additional computing devices running the same service. For example, service registration information associated with the service running on various computing devices may be maintained at a service registration device. The source computing node 302 may issue a query request to the service registration device to query information associated with the computing device that is available for connection. Based on the query result provided by the service registration device, the source computing node 302 may discover the respective target computing node 304. After the source computing node 302 discovers the target computing node 304, the data communication may be established between the source computing node 302 and the target computing node 304 using any known data communication establishment techniques in the prior art. The data communication between the source computing node 302 and the target computing node 304 may include direct communication or indirect communication (e.g., via one or more intermediate devices or media). For example, data communication between the source computing node 302 and the target computing node 304 may be implemented using a variety of wireless communication technologies such as cellular networks, wireless local area networks, Bluetooth, near field communication (NFC), and the like.

After establishing the data communication, the source computing node 302 may send a data request 306 to the target computing node 304 to request metadata of the target computing node 304.

Each computing node may maintain metadata specific for itself. The metadata of a particular computing node may include an identification (ID) of the particular computing node, and the identification is used for uniquely identifying the computing node in the decentralized federated learning system. The metadata of the particular computing node may also include a current model age (age) of the local model of the particular computing node. The current model age is associated with a number of times of model aggregation that the particular computing node and other computing nodes have performed. The initial model age of the computing node that does not perform model aggregation with other computing nodes is zero, and the current model age is progressively increased as the model aggregation operation with other computing nodes is performed. How the current model age of the computing node is updated when performing the model aggregation is further described in detail below.

In response to the data request 306, the target computing node 304 may return a data response 308 to the source computing node 302. The data response 308 may include metadata of the target computing node 304, for example, the identification of the target computing node 304 and the current model age of the local model of the target computing node 304.

Each computing node may also maintain an aggregation history. The aggregation history of the particular computing node is associated with the model aggregation operation that the particular computing node has performed historically. The aggregation history may be embodied in any form of data structure, e.g., tables, lists, and any other data structures may be employed to save the aggregation history.

The aggregation history of the source computing node 302 may include at least one data entry, each data entry being specific for a historical target computing node that has historically performed model aggregation with the particular computing node. Each data entry may include an identification of a historical target computing node and a historical model age of the historical target computing node upon the occurrence of model aggregation between the source computing node 302 and the historical target computing node. In one example, the data entry in the aggregation history may be embodied in a format of a tuple formed by the identification and the historical model age, for example, one tuple may be (“ID1,” “m”) that represents that the source computing node 302 has historically occurred model aggregation with the historical target computing node identified as ID1, and after the model aggregation occurs, the historical model age of the historical target computing node is m.

The target computing node 304 may maintain its own aggregation history in a similar manner.

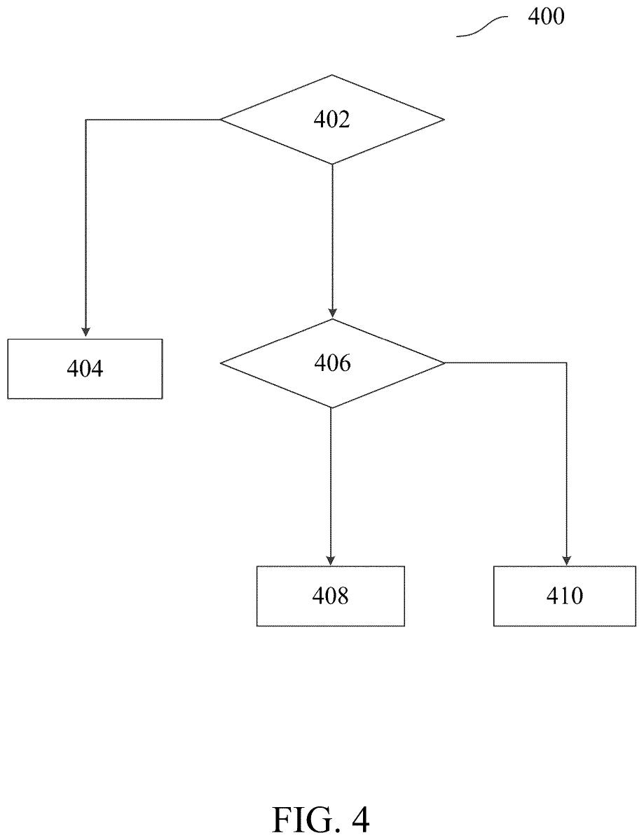

Upon receiving the metadata of the target computing node 304, the source computing node 302 may generate a model aggregation decision 310 based on the received metadata of the target computing node 304 and the aggregation history of the source computing node 302. The generated decision may indicate if the model aggregation needs to be performed with the target computing node 304. The specific process for performing the model aggregation decision 310 is described in further detail below in conjunction with FIG. 4.

In case that the generated decision indicates that the model aggregation with the target computing node 304 is not required to be performed, the source computing node 302 may end the process shown in FIG. 3 and may cut off the data communication with the target computing node 304.

In case that the generated decision indicates that the model aggregation is required to be performed with the target computing node 304, the source computing node 302 may further send a data request 312 to the target computing node 304 to request local model parameters of the local model of the target computing node 304. In response to the data request 312, the target computing node 304 may return the data response 314 to the source computing node 302. The data response 314 may include local model parameters of the local model of the target computing node 304.

Next, the source computing node 302 may perform the model aggregation operation 316. In the model aggregation operation 316, the source computing node 302 may perform the model aggregation on its own local model with the local model of the target computing node 304 to obtain the aggregated model. The source computing node 302 may utilize the model aggregation algorithm to compute the aggregated model parameters based on the received local model parameters of the target computing node 304 and the local model parameters of the source computing node 302. The aggregated model parameters may be computed based on the current model age and local model parameters of the source computing node 302 and the current model age and local model parameters of the target computing node 304. It is advantageous to consider the current model age of the source computing node 302 and the target computing node 304 as variables for computing the aggregated model parameters, at least because the current model age of the computing node is associated with the number of times of model aggregation that the computing node and other computing nodes have performed, and the different number of times of aggregation can affect the computed aggregated model parameters.

The process of computing the aggregated model parameters can be expressed as the following equation:

$$p = f ( {n}_{a} , {p}_{a} , {n}_{b} , {p}_{b} )$$

wherein p is the aggregated model parameters, f( ) is the model aggregation algorithm, na is the current model age of the source computing node 302, pa is the local model parameters of the source computing node 302, nb is the current model age of the target computing node 304, and pb is the local model parameters of the target computing node 304.

In one example, the aggregated model parameters may be computed using an incremental average algorithm based on the following formula:

$$p = \frac{{n}_{a} * {p}_{a} + {n}_{b} * {p}_{b}}{{n}_{a} + {n}_{b}}$$

wherein the meanings of various parameters are consistent with those discussed above, that is, p is the aggregated model parameters, na is the current model age of the source computing node 302, pa is the local model parameters of the source computing node 302, nb is the current model age of the target computing node 304, and pb is the local model parameters of the target computing node 304.

After performing the model aggregation operation 316, the source computing node 302 may update its own local model to the aggregated model. For example, the local model parameters pₐ may be updated as p. The source computing node 302 may also update its own current model age to a sum of the current model age of the source computing node 302 and the current model age of the target computing node 304. For example, the current model age na may be updated to nₐ+n_{b}.

The source computing node 302 may also further update the aggregation history to record information associated with the current model aggregation operation. The source computing node 302 may determine whether a data entry specific for the target computing node 304 already exists in the aggregation history. In the case that the data entry specific for the target computing node 304 already exists in the aggregation history, the source computing node 302 may update the historical model age in the data entry to the sum of the current model age of the source computing node 302 and the current model age of the target computing node 304, i.e., nₐ+n_{b}. In the case that the data entry specific for the target computing node 304 does not exist in the aggregation history, the source computing node 302 may create a new data entry in the aggregation history and write the identification and historical model age of the target computing node 304 in the data entry, wherein the historical model age is the sum of the current model age of the source computing node 302 and the current model age of the target computing node 304, i.e., nₐ+n_{b}.

Although the above description describes how the local model of the target computing node 304 is aggregated from the perspective of the source computing node 302, it should be understood that the target computing node can perform the same operations to aggregate the local model of the source computing node 302. As such, the source computing node 302 shares the same aggregated model parameters (p) as the target computing node 304 and has the same current model age (na+nb). In one example, some mechanisms may be employed to ensure that the data maintained at the source computing node 302 and the target computing node 304 and associated with the model aggregation (including the aggregated model parameters and the current model age+) does not change after the model aggregation occurs and before the next model aggregation (which may be further model aggregation between the source computing node 302 or the target computing node 304 and other computing nodes) occurs, in other words, data associated with the model aggregation is prevented from being tampered. For example, a blockchain technique may be employed to achieve the above data tamper prevention.

FIG. 4 shows a flow chart of a method 400 for performing a model aggregation decision according to one example of the present disclosure. The method 400 may be performed by the source computing node 302 described above in connection with FIG. 3.

At block 402, the source computing node may first determine whether the identification of the target computing node matches an identification in one data entry in the aggregation history.

In response to determining, at block 402, that the identification of the target computing node does not match the identification in any data entry in the aggregation history, thereby indicating that no model aggregation has occurred between the source computing node and the target computing node, at block 404, the source computing node may generate a decision indicative of performing model aggregation such that the local model of the target computing node can be aggregated.

In response to determining, at block 402, that the identification of the target computing node matches the identification in one data entry in the aggregation history, thereby indicating that the model aggregation has occurred historically between the source computing node and the target computing node, at block 406, the source computing node may further compare the current model age of the target computing node to the historical model age in the matched data entry.

If the current model age of the target computing node is greater than the historical model age, thereby indicating that further model aggregation has occurred between the target computing node and other computing nodes since the last model aggregation occurred between the source computing node and the target computing node, at block 408, the source computing node may generate a decision indicative of performing model aggregation such that the updated local model of the target computing node can be aggregated.

If the current model age of the target computing node is equal to the historical model age, at block 410, the source computing node may generate a decision indicative of not performing the model aggregation.

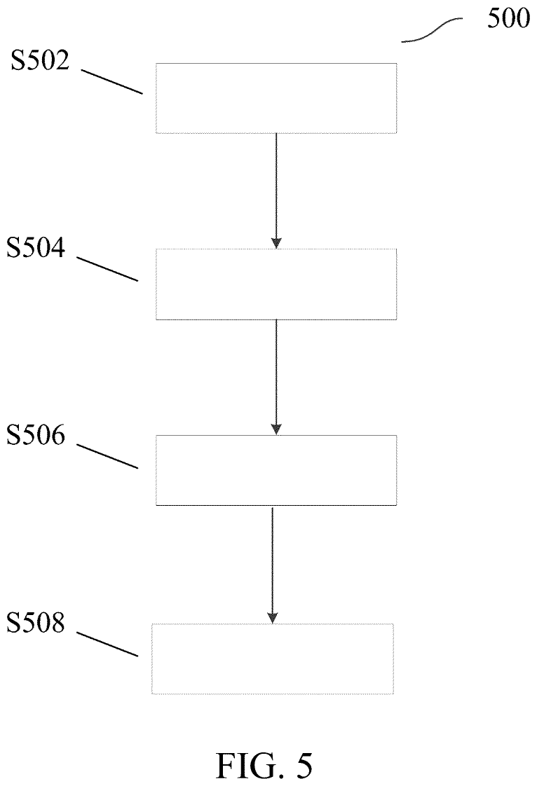

FIG. 5 shows a flow chart of a method 500 for model aggregation in federated learning according to one example of the present disclosure. The flow 500 shown in FIG. 5 may be performed by the source computing node described above in conjunction with FIG. 3 and FIG. 4 to enable the local model of the source computing node to fuse data from the target computing node. The target computing node may similarly perform operations of the process 500 to enable the local model of the target computing node to fuse data from the source computing node. In this instance, the roles of the source computing node and the target computing node are exchanged. In other words, the target computing node may be a subject for performing the process 500, wherein the target computing node may be the source computing node referred to in the process 500, and the source computing node may be the target computing node referred to in the process 500.

At step S502, metadata of the target computing node may be received. The metadata of the target computing node may include the identification of the target computing node and the current model age of the local model of the target computing node. In the same way, the source computing node can also maintain its own metadata. The metadata of the source computing node may be used by the target computing node for performing the process 500. The source computing node may also maintain the aggregation history, the aggregation history may include at least one data entry, and each data entry is specific for a historical target computing node that has historically performed model aggregation with the source computing node. Each data entry may include an identification of a historical target computing node. Each data entry may also include a historical model age of the historical target computing node after the model aggregation between the source computing node and the historical target computing node occurs.

At step S504, a model aggregation decision may be generated based on the received metadata and the aggregation history of the source computing node. For example, the source computing node may first determine whether the identification of the target computing node matches the identification in one data entry in the aggregation history. In an aspect, in response to the identification of the target computing node not matching the identification in any data entry in the aggregation history, the source computing node may generate a decision indicative of performing the model aggregation. In another aspect, in response to the identification of the target computing node matching the identification in one data entry in the aggregation history, the source computing node may further compare the current model age of the target computing node to a historical model age in the matched data entry. If the current model age is greater than the historical model age, the source computing node may generate a decision indicative of performing the model aggregation. If the current model age is equal to the historical model age, the source computing node may generate a decision indicative of not performing the model aggregation.

At step S506, in response to generating a decision indicative of performing the model aggregation, the model aggregation may be performed on the local model of the source computing node and the local model of the target computing node to obtain an aggregated model. For example, in response to the generated decision indicative of requiring to performing the model aggregation, the source computing node may receive local model parameters of the target computing node. The source computing node may then utilize the model aggregation algorithm to compute the aggregated model parameters based on the local model parameters of the received target computing node and the local model parameters of the source computing node. In one example, the model parameters may be computed based on the current model age and local model parameters of the source computing node and the current model age and local model parameters of the target computing node.

At step S508, the local model of the source computing node may be updated to the aggregated model. In addition, the current model age of the source computing node may also be updated to the sum of the current model age of the source computing node and the current model age of the target computing node. The aggregation history may also be updated, such that the historical model age in the data entry of the target computing node is equal to the sum of the current model age of the source computing node and the current model age of the target computing node.

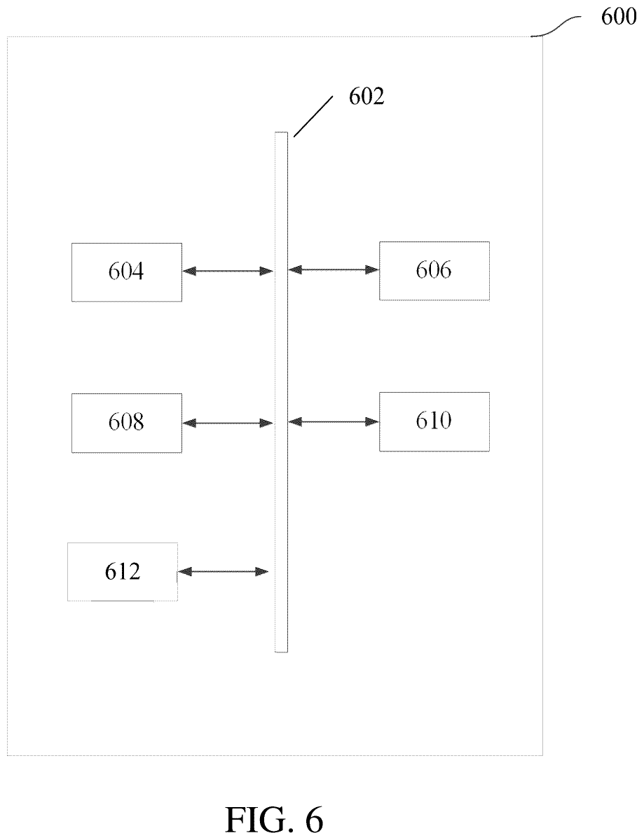

FIG. 6 shows a block graph of a computing device according to one example of the present disclosure, wherein the computing device may implement the above-described method for model aggregation in federated learning. For example, the computing device may include any of the computing nodes discussed above in connection with FIG. 2 or may include the source computing node discussed above in connection with FIGS. 3-5.

The example computing device 600 comprises an internal communication bus 602 and a processor (e.g., a central processing unit (CPU)) 604 connected to the internal communication bus 602, the processor 604 being used for executing instructions stored in a memory 606 to implement the method for model aggregation in federated learning as described in detail above. The memory 606 is suitable for physically embodying computer program instructions and data, and may comprise various forms of memories, for example, semiconductor memory devices such as EPROM, EEPROM, and flash memory devices; magnetic disks such as internal hard disks and removable disks; magneto-optical disks; and CD-ROM disks, etc. The computing device 600 may also include an input/output (I/O) interface 608 such that various I/O devices (e.g., cursor control devices such as mice, keyboards, etc.) may be coupled to the computing device 600 via the I/O interface 608 to allow the user to apply various commands and input data. The computing device 600 may also include a display unit 610 for displaying a graphical user interface. The computing device 600 also includes a communication interface 612 to implement data communication with other computing nodes.

The computer program may include instructions executable by a computer, the instructions being used for causing the processor 604 of the computing device 600 to perform the method for model aggregation in federated learning in the present disclosure. The program may be recorded on any data storage medium, including the memory. For example, the program may be implemented in digital electronic circuits or using computer hardware, firmware, software, or a combination thereof. The process/method steps described in the present disclosure can be performed by a programmable processor executing program instructions to operate on input data and generate output to perform the method steps, processes, operations.

Embodiments of the present disclosure may be implemented in a computer-readable medium. The computer-readable medium may store a computer program comprising instructions. In one example aspect, the instructions, when executed, may cause the at least one processor to: receive metadata of the target computing node; generate a model aggregation decision based on the metadata and an aggregation history of the source computing node; in response to generating a decision indicative of performing the model aggregation, perform model aggregation on a local model of the source computing node and a local model of the target computing node; and update the local model of the source computing node to an aggregated model.

Embodiments of the present disclosure may be implemented in a computer program product. The computer program product may include instructions. In one example aspect, the instructions, when executed, may cause a processor of the computing device to: receive metadata of the target computing node; generate a model aggregation decision based on the metadata and an aggregation history of the source computing node; in response to generating a decision indicative of performing the model aggregation, perform model aggregation on a local model of the source computing node and a local model of the target computing node; and update the local model of the source computing node to an aggregated model.

In addition to the content described in this document, various modifications can be made to the disclosed examples and implementations of the disclosure without departing from the scope of the disclosed examples and embodiments of the disclosure. Therefore, the description and examples herein should be interpreted as illustrative and not restrictive. The scope of the disclosure should only be determined by reference to the claims.

What is claimed is:

1. A method for model aggregation in federated learning, wherein the method is performed by a source computing node, and the source computing node is communicatively coupled with a target computing node, the method comprising:
receiving metadata of the target computing node;
generating a model aggregation decision based on the metadata and an aggregation history of the source computing node;
in response to generating a decision indicative of performing the model aggregation, performing the model aggregation on a local model of the source computing node and a local model of the target computing node to obtain an aggregated model; and
updating the local model of the source computing node to the aggregated model.

2. The method according to claim 1, wherein the metadata of the target computing node comprises:
an identification of the target computing node; and
a current model age of the local model of the target computing node.

3. The method according to claim 2, wherein the aggregation history of the source computing node comprises at least one data entry, each data entry being specific to one historical target computing node that has historically performed model aggregation with the source computing node, and comprises:
an identification of the historical target computing node; and
a historical model age of the historical target computing node after the model aggregation between the source computing node and the historical target computing node occurs.

4. The method according to claim 3, wherein generating the model aggregation decision based on the metadata and the aggregation history of the source computing node comprises:
determining whether the identification of the target computing node matches an identification in one data entry in the aggregation history; and
in response to the identification of the target computing node not matching the identification in any data entry in the aggregation history, generating a decision indicative of performing the model aggregation.

5. The method according to claim 4, further comprising:
in response to the identification of the target computing node matching the identification in one data entry in the aggregation history, comparing the current model age of the target computing node to a historical model age in the matched data entry; and
when the current model age is greater than the historical model age, generating a decision indicative of performing the model aggregation; or
when the current model age is equal to the historical model age, generating a decision indicative of not performing the model aggregation.

6. The method according to claim 2, wherein in response to generating the decision indicative of performing the model aggregation, performing the model aggregation on the local model of the source computing node and the local model of the target computing node to obtain an aggregated model comprises:
receiving local model parameters of the target computing node; and
computing aggregated model parameters by utilizing a model aggregation algorithm based on the received local model parameters of the target computing node and local model parameters of the source computing node.

7. The method according to claim 6, wherein
the local model of the source computing node and the local model of the target computing node are deep learning models; and
the local model parameters comprise weights and bias.

8. The method according to claim 6, wherein computing the aggregated model parameters by utilizing the model aggregation algorithm based on the received local model parameters of the target computing node and the local model parameters of the source computing node comprises:
computing the aggregated model parameters based on the current model age and the local model parameters of the source computing node and the current model age and the local model parameters of the target computing node.

9. The method according to claim 8, wherein the aggregated model parameters are computed as follows:
$$p = \frac{{n}_{a} * {p}_{a} + {n}_{b} * {p}_{b}}{{n}_{a} + {n}_{b}}$$
wherein p is the aggregated model parameters, nₐ is the current model age of the source computing node, pₐ is the local model parameters of the source computing node, n_{b} is the current model age of the target computing node, and p_{b} is the local model parameters of the target computing node.

10. The method according to claim 2, further comprising:
updating the current model age of the source computing node to a sum of the current model age of the source computing node and the current model age of the target computing node.

11. The method according to claim 3, further comprising:
updating the aggregation history, such that the historical model age in the data entry of the target computing node is equal to a sum of the current model age of the source computing node and the current model age of the target computing node.

12. The method according to claim 1, further comprising:
utilizing a blockchain technique to prevent data maintained at the source computing node and the target computing node and associated with the model aggregation from being tampered after the model aggregation occurs and before a next model aggregation occurs.

13. The method according to claim 1, wherein:
the source computing node and the target computing node are computing nodes in a decentralized federated learning system; and
the decentralized federated learning system also comprises a plurality of other computing nodes.

14. The method according to claim 13, further comprising:
performing a service discovery process to discover the target computing node in the decentralized federated learning system; and
upon discovering the target computing node, establishing data communication with the target computing node in order to implement communication coupling with the target computing node.

15. The method according to claim 13, further comprising:
performing model aggregation on the source computing node and at least one of the plurality of other computing nodes, respectively.

16. The method according to claim 1, wherein:
the source computing node and the target computing node are computing devices of autonomous vehicles, respectively; and
the aggregated model is used by the source computing node for generating a driving control decision for controlling driving of the autonomous vehicles according to environmental perception information.

17. The method according to claim 1, wherein:
the source computing node and the target computing node are cell phones, respectively; and
the aggregated model is used by the source computing node for generating a recommended result that comprises content that may be of interest to a user according to user data.

18. A device for model aggregation in federated learning, comprising:
a non-transitory memory; and
a processor coupled to the non-transitory memory, the processor being configured to perform the method according to claim 1.

19. A non-transitory computer-readable medium storing a computer program comprising instructions, the instructions, when executed by a processor, causing the processor to be configured to perform the method according to claim 1.

20. A computer program product, comprising instructions, the instructions, when executed by a processor of a computing device, causing the processor to be configured to perform the method according to claim 1.
